(19) United States
(12) Patent Application Publication
(10) Pub. No.: US 2023/0031340 A1
(43) Pub. Date: Feb. 2, 2023

(54) OUTDOOR COOKING STATION WITH MULTIPLE INDEPENDENT COOKING MODES AND METHOD THEREOF

(71) Applicant: North Atlantic Imports, LLC, Logan, UT (US)

(72) Inventors: Roger Dahle, Providence, UT (US); Steve L. Puertas, Wellsville, UT (US); James C. Bush, III, Providence, UT (US)

(21) Appl. No.: 17/887,024

(22) Filed: Aug. 12, 2022

Related U.S. Application Data
(63) Continuation-in-part of application No. 17/407,704, filed on Aug. 20, 2021.
Application No. 17/407,704 is a continuation of application No. 16/428,605, filed on May 31, 2019, now Pat. No. 11,116,360.
(60) Provisional application No. 63/232,630, filed on Aug. 12, 2021.
(60) Provisional application No. 62/678,436, filed on May 31, 2018.

(51) Int. Cl. A47J 37/07; A23L 5/10; A47J 37/06; A23B 4/052

(52) U.S. Cl. CPC A47J 37/0713; A47J 37/0709; A23L 5/15; A47J 37/0682; A23B 4/052; A23V 2002/00

(57) ABSTRACT

An outdoor cooking station configured to simultaneously and independently cook food with separate cooking modes. The cooking station includes a main body extending to define a griddle portion and an oven portion. The griddle portion includes a griddle member having a flat griddle surface such that the griddle member is configured to be supported by the main body. The oven portion is positioned adjacently to one side of the griddle member, the oven portion including a cooking chamber defined by a lower stone and an upper stone and an internal wall, the lower stone including a stone cooking surface. With this arrangement, the stone cooking surface and the griddle cooking surface are sized and configured to cook food independently from each other.

### CROSS-REFERENCE TO RELATED APPLICATIONS

This application claims the benefit of U.S. Provisional Application No. 63/232,630, filed Aug. 12, 2021, the disclosure of which is hereby incorporated by reference herein in its entirety. Further, this application is a continuation-in-part of U.S. patent application Ser. No. 17/407,704, filed Aug. 20, 2021, which is a continuation of U.S. patent application Ser. No. 16/428,605, filed May 31, 2019, and now U.S. Pat. No. 11,116,360, which claims the benefit of U.S. Provisional Application No. 62/678,436, filed May 31, 2018, the disclosures of which are hereby incorporated by reference herein in their entirety.

### TECHNICAL FIELD

The present invention relates generally to outdoor type cooking stations and, more specifically, the present invention relates to independent cooking modes within a single stand-alone outdoor cooking station.

### BACKGROUND

Barbequing has become a popular and pervasive tradition in much of the world. A barbeque grill is a device for cooking food by applying heat directly below a grill. There are several varieties of grills but most fall into one of two categories, either gas fueled or charcoal. Gas fueled grills typically use propane or natural gas as a fuel source, with the gas flame either cooking the food directly or heating grilling elements which in turn radiate the heat necessary to cook the food. As such, grilling has become a popular method of cooking food due to the unique flavors and texture imparted to the food during the grilling process.

Another form of grilling that imparts unique flavors and texture to food is by employing a griddle. The griddle is a cooking device consisting of a broad flat surface that can be heated over, for example, a gas fueled open flame and is used in both residential and commercial applications. The griddle is most commonly a flat metal plate composed of cast or wrought iron, aluminum or carbon steel.

Further, another mode of grilling that imparts unique flavors to food is grilling with a smoker device. The smoker device uses pellets as a fuel source and, as the pellets are burned, the pellets provide heated smoke to a substantially enclosed chamber to impart flavor to the food through the cooking process. Those desiring to cook food with a smoker device and a griddle or grilling barbeque station are often limited by the space available on their back patio or deck and, therefore, will likely only choose one or the other type of cooking stations in order to enjoy barbequing their food. Another distinct mode for cooking food in the outdoors is by baking food with, for example, a pizza oven.

### BRIEF SUMMARY OF THE INVENTION

The present invention is directed to various embodiments of an outdoor cooking station configured to simultaneously and independently cook food with separate cooking modes. In one embodiment, the outdoor cooking station includes a main body extending to define a griddle portion and an oven portion. The griddle portion including a griddle member having a flat griddle surface such that the griddle member is configured to be supported by the main body and positioned above one or more first gas burners. The oven portion is positioned adjacently to one side of the griddle member, the oven portion including a cooking chamber defined by a lower stone and an upper stone and an internal wall, the internal wall acting as a heat shield relative to an outer wall of the oven portion, the lower stone having a stone cooking surface positioned adjacent one or more second gas burners. The stone cooking surface and the griddle cooking surface are sized and configured to cook food independently from each other such that the one or more first gas burners are dedicated to solely heat the griddle cooking surface and the one or more second gas burners are dedicated to solely heat the stone cooking surface within the cooking chamber of the oven portion.

In another embodiment, the main body includes one or more heat shields extending below the one or more first gas burners and between the griddle portion and the oven portion of the main body. In another embodiment, the griddle portion includes a griddle hood pivotably coupled to the griddle member. In another embodiment, the cooking station includes burner knobs, some of the burner knobs solely dedicated to the griddle portion and one or more of the burner knobs solely dedicated to the oven portion. In still another embodiment, the lower stone is positionable on a support panel, the support panel being sized and configured to rotate for rotating the stone cooking surface. In yet another embodiment, the griddle portion and the oven portion are heated with gas flame burners, the gas flame burners associated with the griddle portion are dedicated solely to the griddle portion and one or more of the gas flame burners associated with the oven portion are dedicated solely to the oven portion.

In accordance with another embodiment of the present invention, a portable outdoor cooking station configured to simultaneously and independently cook food with a first fuel source and a second fuel source is provided. The portable outdoor cooking station including a main body, a griddle portion, and an oven portion. The main body extends to define a front side, a rear side, a left side and a right side each extending between a lower end and an upper portion of the main body. Further, the main body is associated with one or more first gas flame burners and one or more second gas flame burners each controlled along the front side and coupled to the main body. The griddle portion includes a griddle configured to be supported by the upper portion of the main body and positioned above the one or more first gas flame burners, the griddle having a flat griddle cooking surface with a splash guard extending upward from a periphery of the flat griddle cooking surface. The oven portion extends to define an external wall with an oven opening defined therein, the oven opening sized and configured to access a cooking chamber of the oven portion. The cooking chamber is defined by an internal wall structure and a flat stone cooking surface, the internal wall structure spaced from the external wall to define an air gap therebetween. The oven portion is supported by the main body and heated by the one or more second gas flame burners. With this arrangement, the flat griddle cooking surface and the flat stone cooking surface are each configured to cook food independent of each other and simultaneously from the first fuel source and the second fuel source, respectively.

In another embodiment, the main body includes one or more heat shields extending below the one or more first gas flame burners and between the griddle portion and the oven portion of the main body. In another embodiment, the internal wall structure includes an upper stone, the upper stone extending substantially parallel relative to the flat stone cooking surface. In another embodiment, the internal wall structure includes a heat shield, the heat shield extending to at least partially surround the flat stone cooking surface. In still another embodiment, the flat stone cooking surface includes a lower stone, the lower stone positioned on a support panel such that the support panel is positioned adjacent the one or more second gas flame burners. In yet another embodiment, the support panel further includes a rod coupled centrally to the support panel, the rod extending downward from the support panel to a motor, the motor configured to rotate the rod so that the support panel and the lower stone rotate. In another embodiment, the one or more second gas flame burners is positioned below the support panel so that heat from the one or more second gas flame burners moves along an underside of the support panel and so that heat moves upward through a gap between the support panel and the internal wall structure.

In another embodiment, the one or more first gas flame burners is coupled to a first hose, the first hose configured to feed fuel from the first fuel source and to the one or more first gas flame burners, and the one or more second gas flame burners is coupled to a second hose, the second hose configured to feed fuel from the second fuel source and to the one or more second gas flame burners. In another embodiment, the first and second hoses are not interconnected. In another embodiment, the main body includes burner knobs along the front side of the main body, some of the burner knobs solely dedicated to control gas flow through the one or more first gas flame burners to provide heat to the griddle portion, and some of the burner knobs solely dedicated to control gas flow through the one or more second gas flame burners to provide heat to the oven portion. In another embodiment, the griddle portion includes a griddle hood, the griddle hood sized and configured to cover the flat griddle cooking surface. In still another embodiment, the hood is pivotably coupled to the griddle portion so that the griddle hood is moveable between a closed position and an open position.

In accordance with another embodiment of the present invention, a method for cooking food in the outdoors with a first fuel source and a second fuel source is provided. The method includes the step of: providing a portable outdoor cooking station with a main body, the portable outdoor cooking station extending to define a griddle portion and an oven portion each supported by the main body, the griddle portion including a griddle cooking surface positioned above one or more first gas flame burners, the oven portion including an external wall defining an oven opening therein for accessing a cooking chamber, the cooking chamber defined by an internal wall structure and a stone cooking surface such that the cooking chamber is configured to be heated with one or more second gas flame burners; heating the griddle cooking surface with the one or more first gas flame burners that are configured to receive fuel from the first fuel source and configured to solely heat the griddle cooking surface; and heating the cooking chamber with the one or more second gas flame burners that are configured to receive fuel from the second fuel source and configured to solely heat the cooking chamber of the oven portion.

In another embodiment, the method further includes minimizing heat flow from the heating the griddle cooking surface toward the cooking chamber of the oven portion with one or more heat shields positioned adjacent to the one or more first gas flame burners of the griddle portion. In another embodiment, the heating the griddle cooking surface step includes activating one or more first burner knobs positioned along a first side of the main body and directly linked to the one or more first gas flame burners. In another embodiment, the heating the cooking chamber step includes activating one or more second burner knobs positioned along a second side of the main body and directly linked to the one more second gas flame burners. In another embodiment, the heating the griddle cooking surface and the heating the cooking chamber steps include heating the griddle cooking surface and the cooking chamber independently and simultaneously.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a cooking station having both a griddle cooking portion and a smoker cooking portion, according to an embodiment of the present invention;

FIG. 2 is a partially exploded perspective view of the cooking station of FIG. 1, depicting heating elements for the griddle cooking portion and a door of a smoker chamber in an open position, according to another embodiment of the present invention;

FIG. 3 is a cross-sectional perspective view of the cooking station taken along section line A-A of FIG. 1, according to another embodiment of the present invention;

FIG. 4 is a front cross-sectional view of the cooking station taken along section line A-A of FIG. 1, according to another embodiment of the present invention;

FIG. 5 is an enlarged front cross-sectional view of a pellet feeder system, according to another embodiment of the present invention;

FIG. 6 is a schematic view of a control system associated with the cooking station of FIG. 1, according to another embodiment of the present invention;

FIG. 7 is a perspective front view of another embodiment of an outdoor cooking station, depicting a first cooking portion and a second cooking portion in a side-by-side arrangement, according to the present invention;

FIG. 8 is a partial cross-sectional view of the first and second cooking portions of the cooking station taken along section line B-B of FIG. 7, according to another embodiment of the present invention;

FIG. 9 is a perspective view of another embodiment of a cooking station, depicting the cooking station having a griddle portion and an oven portion positioned in a side-by-side manner, according to the present invention;

FIG. 10 is a perspective view of the cooking station of FIG. 9, depicting a hood of the griddle portion in an open position, according to another embodiment of the present invention;

FIG. 11 is a front view of the cooking station, according to another embodiment of the present invention;

FIG. 12 is a side view of the cooking station, according to another embodiment of the present invention;

FIG. 13 is a perspective cross-sectional view of the cooking station taken along section line 13-13 of FIG. 12, according to another embodiment of the present invention;

FIG. 14 is a perspective cross-sectional view of the cooking station taken along section line 14-14 of FIG. 12, according to another embodiment of the present invention;

FIG. 15 is a cross-sectional view of the cooking station taken along section line 15-15 of FIG. 11, according to another embodiment of the present invention; and

FIG. 16 is a cross-sectional view of the cooking station taken along section line 16-16 of FIG. 12, according to another embodiment of the present invention.

### DETAILED DESCRIPTION OF THE INVENTION

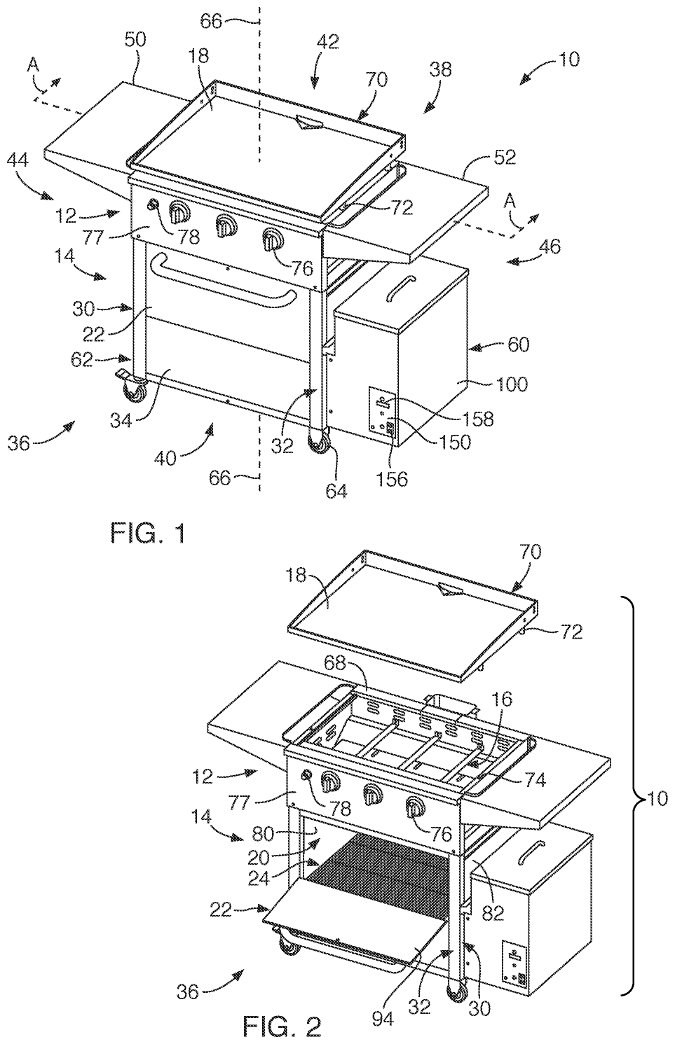

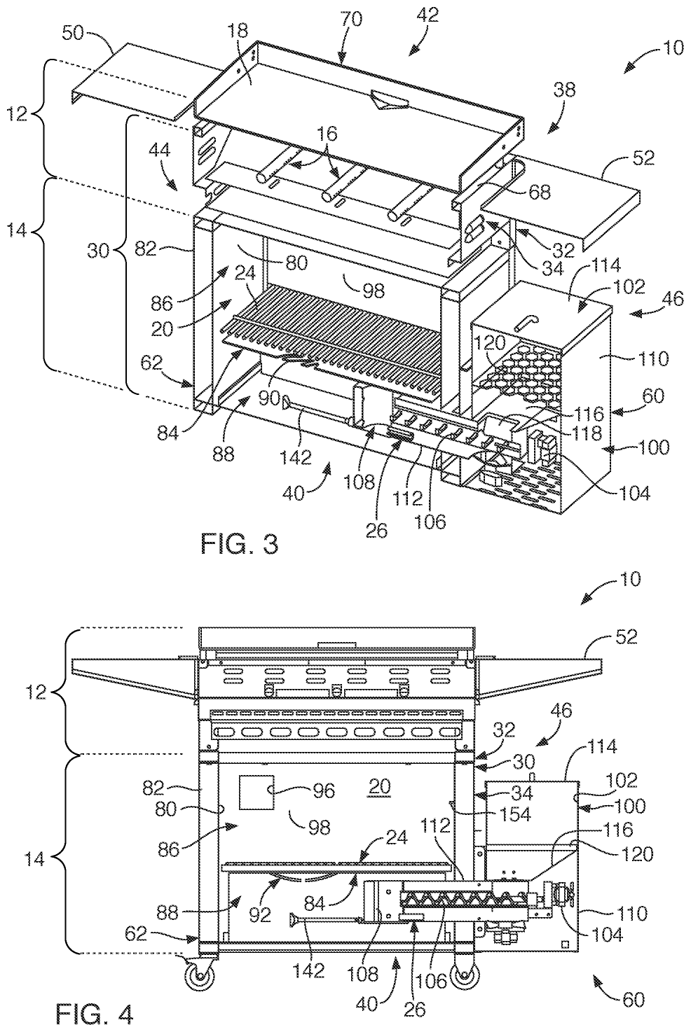

Referring to FIGS. 1 and 2, one embodiment of a cooking station 10 sized and configured to cook food with separate and independent cooking modalities or modes is provided. The cooking station 10 may be an outdoor type cooking station. Further, the cooking station 10 may include structural characteristics that facilitate portability of the cooking station 10. The cooking station 10 may include an upper cooking portion 12 and a lower cooking portion 14 such that each cooking portion is separate and independent from the other and may be employed to cook food simultaneously with the cooking station 10. The upper cooking portion 12 may include a first heating element 16 that may be gas fueled and sized and configured to heat a first cooking surface 18, such as a grill structure or griddle member. The lower cooking portion 14 may be in the form of a smoker chamber 20 accessible with a door 22, the smoker chamber 20 including a second cooking surface 24 suspended above a second heating element 26 (FIG. 3). The second heating element 26 may be sized and configured to electrically heat pellet elements (not shown) to supply heated smoke to the second cooking surface 24 within the chamber 20. In this manner, the cooking station 10 may be employed to cook food simultaneously in different cooking modes and with independent, separate, and different heat sources, each cooking mode providing a unique flavor and texture to the food being cooked. As such, the cooking station 10 provides a compact and portable outdoor cooking station that facilitates cooking food in at least two different cooking modes that traditionally would require at least two separate stand-alone cooking stations.

With reference to FIGS. 1-3, the cooking station 10 may include a main body 30 extending to define and support the upper and lower cooking portions 12, 14. The main body 30 may include frame components 32 with various panels 34 secured to the frame components 32 to define the upper and lower cooking portions 12, 14. For example, the frame components 32 may extend with vertically extending frame components and horizontally extending frame components with the panels 34 attached thereto to define a front side 36, a rear side 38, a bottom side 40, a top side 42, a first side 44 and a second side 46 of the main body 30. The front side 36 may generally face opposite relative to the rear side 38 of the main body 30. Likewise, the bottom side 40 may generally face opposite relative to the top side 42 or upper side, and the first side 44 may face generally opposite from the second side 46 of the main body 30. In this manner, the main body 30 may externally extend to define a generally box-shaped cubical structure. Further, the cooking station 10 may include a first side shelf 50 and a second side shelf 52 attached to first and second sides 44, 46 of the main body 30 such that the first and second side shelves 50, 52 may be generally level with the top side 42 of the main body 30. In another embodiment, the first and second side shelves 50, 52 may be off-set to a lower position relative to the top side 42 of the main body 30. Also, the second side 46 (or the first side 44) of the main body 30 may include a pellet feeder system 60 coupled to a lower portion 62 of the main body 30, discussed in more detail herein, such that a portion of the pellet feeder system 60 may be positioned below the second side shelf 52. Further, at the lower portion 62 of the main body 30, the main body 30 may include caster wheels 64 or the like to be coupled at an end of legs or the vertically extending frame components so as to facilitate portability of the cooking station 10. In one embodiment, the main body 30 may include four caster wheels 64. In another embodiment, the main body 30 may include two caster wheels 64. In another embodiment, the caster wheels 64 may be coupled directly to vertically extending frame components. In another embodiment, the caster wheels 64 may be coupled to horizontally extending frame components adjacent to the bottom side 40 of the main body 30.

Within the main body 30, the upper cooking portion 12 may be positioned directly above the lower cooking portion 14 such that a vertically extending central axis 66 of the main body 30 may extend centrally through the upper and lower cooking portions 12, 14 and, further, such that the central axis 66 extends centrally through the first and second cooking surfaces 16, 24. In regard to the upper cooking portion 12, the frame components 32 with the panels 34 attached thereto may define an open-ended box-like structure extending upward from the lower cooking portion 14 to an upper edge 68. The panels 34 of the upper cooking portion 12, along the rear side 38, the first side 44, and second side 46 may include venting structure defined therein.

The upper edge 68 may extend horizontally to define a rectangular periphery that may define the top side 42 of the main body 30. Such upper edge 68 may extend adjacent to the first cooking surface 18. In one embodiment, the first cooking surface 18 may be a flat surface and may extend to define a griddle member 70 such that the upper edge 68 may be sized and configured to support the griddle member 70. For example, the griddle member 70 may include griddle legs 72 that extend from a bottom surface of the griddle member 70 such that the griddle legs 72 may be sized to sit within apertures 74 defined on the first and second sides 44, 46 of the upper edge 68 of the main body 30. In another embodiment, the upper edge 68 of the main body 30 may extend adjacent to a grill member (not shown) extending between opposite sides of the upper edge 68, such as between first and second sides 44, 46 and front and rear sides 36, 38 of the upper edge 68. In still another embodiment, the upper edge 68 of the upper cooking portion 12 of the main body 30 may be sized and configured to support a pivoting hood (not shown) or the like associated with the main body 30, the hood being pivotably coupled to the rear side 38 of an upper cooking portion 12 of the main body 30, such as adjacent the rear side 38 of the upper edge 38.

Further, the front side 36 of the upper cooking portion 12 may include multiple burner control valves 76 or knobs positioned over a front panel 77. Each of the burner control valves 76 or knobs may be associated with one of the first heating elements 16 or flame burners. The first heating elements 16 may extend between the front side 36 and rear side 38 of the main body 30 below the upper edge 68 of the main body 30 such that the first heating elements 16 may be secured to the frame components 32 extending within and adjacently along the front and rear sides 36, 38 of the main body 30. Each of the first heating elements 16 may hold structure for feeding pressurized fuel therethrough, such as propane gas or natural gas, and controlled with the burner control valves 76 or knobs. In addition, the front panel 77 may include an ignitor switch 78 that may be depressed to provide a spark to ignite the gas fueled first heating elements 16. The cooking station 10 may include various typical components to facilitate igniting the first heating elements 16 and heating the first cooking surface 18 associated with the cooking station 10, such as various valves, tubing, manifold, gas couplings, fasteners, and any other components, as known to one of ordinary skill in the art. Further, the cooking station 10 may include a propane tank holder (not shown) attached to the lower portion 62 of the main body 30, such as adjacent the first side 44, second side 46, or rear side 38 of the main body 30. The propane tank holder may support a propane tank (not shown) thereon which may be coupled to the cooking station 10 via the typical components for feeding propone to the first heating elements 16, as known by one of ordinary skill in the art. With this arrangement, the cooking station 10 may be employed for heating the first cooking surface 18 for cooking food with the upper cooking portion 12 of the cooking station 10.

Now with reference to FIGS. 2, 3 and 4, the lower cooking portion 14 of the main body 30 of the cooking station 10 may extend with the frame components 32 and panels 34 attached thereto so as to generally define a cubical shaped chamber, such as the before discussed smoker chamber 20. For example, some of the frame components 32 may extend vertically downward directly from the upper cooking portion 12 and some of the frame components 32 may extend horizontally below the upper cooking portion 12 and along a bottom of the lower cooking portion 14 (or bottom side 40 of the main body 30) so that the panels 34 may be coupled thereto to define walls of the lower cooking portion 14. The walls of the lower cooking portion 14 may define inner and outer panels 80, 82 extending to define the lower cooking portion 14. In one embodiment, the inner and outer panels 80, 82 may extend to define a space therebetween that may include insulation material or the like within the space between the inner and outer panels 80, 82.

The lower cooking portion 14 and the smoker chamber 20 may be separated by a horizontally suspended panel or smoke shield 84 to define an upper smoker portion 86 (or upper region) and a lower smoker portion 88 (or lower region) of the smoker chamber 20. Such smoke shield 84 may sit over brackets or the like for suspending the smoke shield 84 horizontally along a mid-portion of the smoke chamber 20. Further, the smoke shield 84 may define an aperture 90 or smoke opening therein that may be off-set relative to the second heating element 26 positioned in the lower smoker portion 88, the aperture 90 including a screen or grate like structure so as to minimize ash from passing through the aperture 90, but also facilitate smoke for passing through the screen and aperture 90 defined in the smoke shield 84. The aperture 90 may be defined with bowed structure 92 extending slightly downward in a bowing manner from the remaining structure of the smoke shield 84. Further, the upper smoker portion 86 of the smoke chamber 20 may include a smoke outlet 96 defined in a vertically extending rear panel 98 of the lower cooking portion 14 such that the smoke outlet 96 may be positioned along the rear panel 98 within an upper portion of the upper smoker portion 86. In one embodiment, the smoke outlet 96 may include moveable structure to facilitate minimizing and enlarging the size of the smoke outlet 96, such as a slideable plate that may be pivotably moveable or linearly moveable over the smoke outlet 96.

The upper smoker portion 86 of the lower cooking portion 14 or smoke chamber 20 may include the second cooking surface 24 or grate like structure that may be suspended by brackets or a ledge within the upper smoker portion 86 and above the smoke shield 84. In another embodiment, the second cooking surface 24 may be in the form of hooks for suspending food in the smoke chamber 20 and may be included additionally to the grate like structure. Such second cooking surface 24 and upper smoker portion 86 may be accessible from the front side 36 of the lower cooking portion 14 with the door 22. Such door 22 may be pivotably coupled to the front side 36 of the main body 30 along a bottom end of the door 22 with, for example, hinge components positioned adjacent bottom corners of the door 22. In this manner, the door 22 may be pivotably coupled so as to be movable between an open position and a closed position. With the door 22 in the open position, the upper smoke portion may be accessible for placing and removing food positioned on the second cooking surface 24. Further, in the open position, the second cooking surface 24 and the smoke shield 84 may be removed from the upper smoker portion 86 for cleaning purposes and for accessing the lower smoker portion 88.

With the door 22 in the closed position, the lower cooking portion 14 and the smoke chamber 20 may be sized and configured to hold heated smoke therein so as to slowly cook food positioned on the second cooking surface 24 or grate. In one embodiment, the door 22 may be spring biased to the closed position. The door 22, such as along an inner peripheral surface 94 of the door 22, may sit against the main body 30 such that a resilient material (not shown) disposed between the inner peripheral surface 94 and the main body 30 may substantially seal the door 22 in the closed position. In this manner, heated smoke may be maintained in the smoke chamber 20 so that smoke leaking from the smoke chamber 20 is minimal except though the smoke outlet 96 defined in the main body 30, such as in the rear panel 98 of the lower cooking portion 14. The user may control the amount of smoke escaping through the smoke outlet 96 by modifying the size of the smoke outlet 96, as previously set forth.

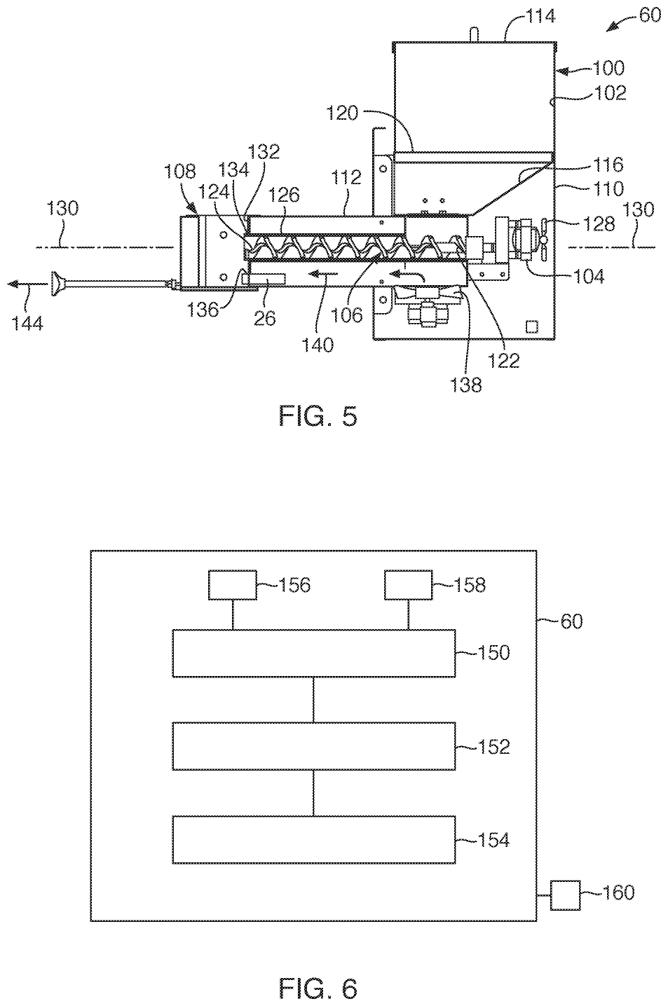

Now with reference to FIGS. 3, 4, and 5, as previously set forth, the pellet feeder system 60 may be attached to the lower portion 62 of the main body 30 along the second side 46 of the main body 30. In one embodiment, the pellet feeder system 60 may be at least partially positioned below the second side shelf 52 of the cooking station 10. The pellet feeder system 60 may be sized and configured to feed pellets to the second heating element 26 for generating heated smoke to the smoke chamber 20. Such pellet feeder system 60 may include a housing 100, a pellet hopper 102, a motor 104, an auger 106, and the second heating element 26, each of which cooperate together to feed pellets to a pellet cup 108 coupled to and/or supporting the second heating element 26. The housing 100 of the pellet feeder system 60 may define an upright extending portion 110 and a laterally extending portion 112, the upright extending portion 110 having a generally cubical external shape with the lateral portion 112 extending from the upright portion 110 and into the lower smoker portion 88. The upright extending portion 110 of the housing 100 may hold the pellet hopper 102, the motor 104 and a portion of the auger 106. The upright extending portion 110 of the housing 100 may include a lid 114 at a top end of the housing 100 that may be pivotably coupled to the top end so that the inside of the pellet hopper 102 may be accessed to pour pellets therein. The laterally extending portion 112 of the housing 100 may hold the remaining portion of the auger 106 and may extend laterally from a lower portion of the upright extending portion 110 of the housing 100.

The pellet hopper 102 may be defined at least partially by the housing 100 of the upright extending portion 110. For example, the pellet hopper 102 may be defined by a hopper floor 116 and an upper portion of the upright extending portion 110 of the housing 100. The pellet hopper 102 may be sized and configured to hold pellets (not shown) therein and to funnel the pellets to an auger entry portion 118. As such, the hopper floor 116 may be oriented at an angled position so that the pellets may funnel toward the auger entry portion 118 of the pellet hopper 102. Further, the pellet hopper 102 may include a screen 120 or grate structure therein to screen clumped pellets from moving to the auger entry portion 118 of the pellet hopper 102. The auger 106 may extend horizontally with a helical configuration between a first end 122 and a second end 124 such that the auger 106 extends through a tube 126. The first end 122 of the auger 106 may be coupled to the motor 104 to facilitate rotation of the auger 106, as known to one skilled in the art. The motor 104 may be an electrically driven motor with a first fan 128 positioned adjacent thereto to assist in cooling the motor 104. As the motor 104 rotates the auger 106 about an auger axis 130 thereof, the auger 106 may feed pellets through the tube 126 and into the pellet cup 108. In this manner, the end of the tube 126 and second end 124 of the auger 106 may be positioned adjacent an upright wall 132 of the pellet cup 108.

The pellet cup 108 may include the upright wall 132 with an upper hole 134 and a lower hole 136 each defined in the upright wall 132, the upper hole 134 positioned directly above the lower hole 136 of the pellet cup 108. The pellet cup 108 may support the tube 126 such that the end of the tube 126 and second end 124 of the auger 106 may be positioned slightly through the upper hole 134 of the pellet cup 108. The lower hole 136 of the pellet cup 108 may hold the second heating element 26 such that the second heating element 26 extends through the lower hole 136 and may be disposed below the end of the tube 126. The second heating element 26 may be electrically heated, as known to one of ordinary skill in the art, so as to burn the pellets feeding in the pellet cup 108 to generate heated smoke. The pellet feeder system 60 may also include a second fan 138. The second fan 138 may be employed to provide air flow, as shown by arrow 140, to the burning pellets so that the burning pellets may be fueled to burn hotter in the pellet cup 108. The second fan 138 may be positioned below the laterally extending portion 112 and within the upright extending portion 110 of the housing 100. The pellet cup 108 may include appropriate venting to facilitate the air flow to the pellets within the pellet cup 108. With this arrangement, the second heating element 26 may burn pellets being fed within the pellet cup 108 and air flow may fan the burning pellets to increase the heat produced by the burning pellets.

Further, the pellet cup 108 may be removed or partially removed from an end of the laterally extending portion 112 of the housing 100 so that ash built-up in the pellet cup 108 may be removed. For example, the pellet cup 108 may be removed by pulling on a slideable rod 142 extending from the pellet cup 108, as shown by arrow 144. Such rod 142 may also be rotatable and slidable in order to decouple the pellet cup 108 (or a portion thereof) from the housing 100. In this manner, as ash is formed from burning the pellets with the second heating element 26, a user may access the lower smoker portion 88 of the smoker chamber 20, de-couple the pellet cup 108 and discard the ash therein. The user may then re-attach the pellet cup 108 in its appropriate position in the smoker chamber 20.

In another embodiment, with reference to FIGS. 1, 4 and 6, the pellet feeder system 60 may include a control panel 150 positioned on, for example, the front side 36 of the housing 100 of the pellet feeder system 60. The control panel 150 may be coupled to a controller 152 and a temperature sensor 154. The control panel 150 may include input controls 156, such as input buttons, and an output 158, such as a display. Further, the pellet feeder system may be coupled to a power connection 160 for electrically powering the components coupled to the control panel 150 as well as the other components of the pellet feeder system 60, as known to one of ordinary skill in the art. The controller 152 may be sized and configured to control components of the pellet feeder system 60, such as the motor 104, the second heating element 26, and the first and second fans 128, 138. The temperature sensor 154 may be positioned within or adjacent the inner panel 80 of the upper smoker portion 86 and may be sized and configured to sense an actual temperature of the upper smoker portion 86, such that the actual temperature may be viewable on the display of the control panel 150. With this arrangement, a user of the lower cooking portion 14 of the cooking station 10 may employ the input controls 156 to input a period of time for cooking the food product in the smoker chamber 20 as well as input a desired temperature for maintaining the smoker chamber 20 of the cooking station 10 over the period of time. The controller 152 in cooperation with the temperature sensor 154 may control activation and deactivation of the motor 104 for supplying pellets via the auger 106 into the pellet cup 108 as well as activate and deactivate heating the second heating element 26 to burn the pellets to generate heated smoke. The controller 152 may also control running the second fan 138 to provide air flow to the pellet cup 108 with the burning pellets to assist in the pellets burning hotter to generate additional heated smoke. Further, the controller 152 may control the first fan 128 to assist in cooling the motor 104.

Upon the actual temperature of the smoker chamber 20 meeting the desired temperature previously set with the input controls 156, as sensed by the temperature sensor 154, the controller 152 may maintain the actual temperature to about the desired temperature in the smoker chamber 20 by activating the motor 104, the second fan 138, and/or the second heating element 26, as needed. In this manner, the actual temperature of the smoker chamber 20 may be maintained to approximately the desired temperature for the period of time set with the input controls 156 on the control panel 150. Further, in another embodiment, the input and output controls may be controlled and viewed remotely with application software via the Internet from a user's mobile phone. Such remote control may be advantageous due to the long period of time required to cook food through heated smoke in the smoker chamber 20.

At any time, such as while cooking food in the smoker chamber 20, a user may cook other food with the gas fueled first heating element 16 (FIG. 2) on the first cooking surface 18, such as on the griddle member 70 or on a grill structure, as previously set forth. As such, the cooking station 10 provides a single portable compact unit that may be employed to cook food in different cooking modes, one cooking mode being gas fueled and the other cooking mode being electrically activated to burn pellets for generating heated smoke. In this manner, a user of the cooking station 10 can slowly cook food in the smoker chamber 20 over a long period of time to obtain the desired smoked flavor in the food while also being able to employ another cooking mode with the cooking station 10, independent of the smoker chamber 20, to cook over gas fueled burners to heat the griddle member 70 of the cooking station 10.

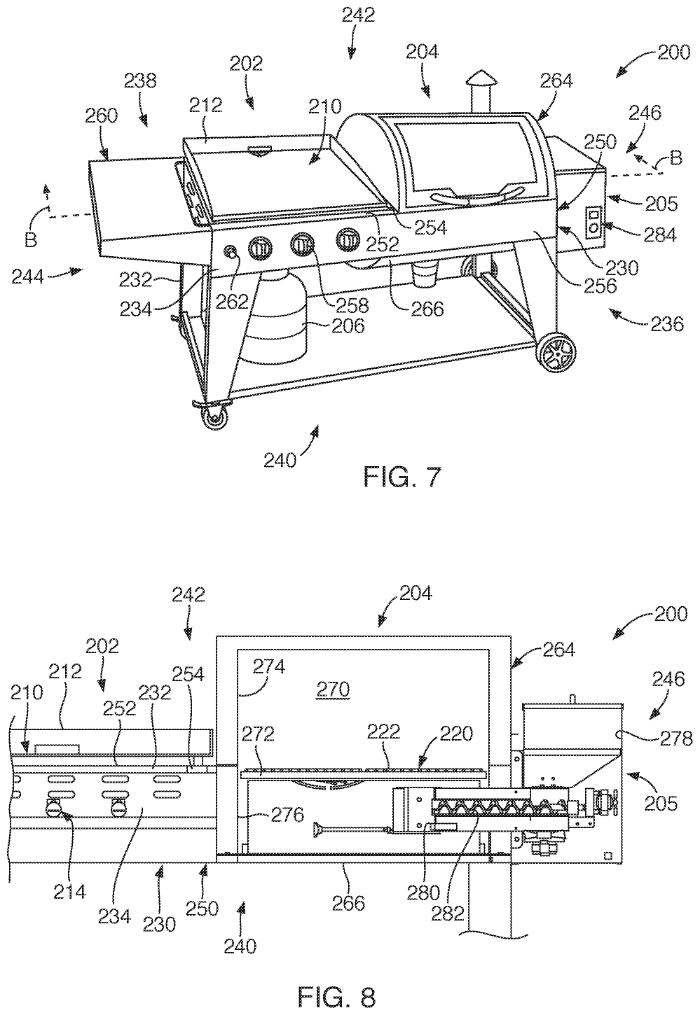

With reference to FIGS. 7 and 8, another embodiment of a cooking station 200 with duel cooking modes is provided. In this embodiment, the cooking station 200 may include similar functionality as the previous embodiment, except instead of the cooking station having the duel cooking modes in a stacked arrangement, the duel cooking modes may be in a side-by-side arrangement within a stand-alone portable cooking unit. For example, the cooking station 200 may include a first cooking portion 202 and a second cooking portion 204 each with separate first and second fuel sources. The first fuel source may be fueled with gas from, a propane tank 206, or natural gas fed via gas lines, for example. The second fuel source may be a pellet feeder system 205, electrically heating/burning pellets (not shown) to create heated smoke. As such, the first cooking portion 202 may include a first cooking surface 210, such as a griddle member 212, which may be heated via first heating elements 214 fueled by the first fuel source, similar to that described and depicted for the upper cooking portion 12 of the cooking station 10 of FIGS. 1 and 2. The second cooking portion 204 may include a second cooking surface 220, such as a grill 222 or hooks, similar to the second cooking surface 24 described and depicted in FIG. 2. Further, the pellet feeder system 205 cooperating with the second cooking portion 204 of this embodiment may include the same components of the pellet feeder system 60 described and depicted relative to FIGS. 3-6.

The cooking station 200 of this embodiment may include a main body 230 extending with frame components 232 and panels 234 to define a front side 236, a rear side 238, a bottom side 240, a top side 242, a first side 244 and a second side 246. The front side 236 may be oppositely positioned relative to the rear side 236. The bottom side 240 may be opposite the top side 242. Similarly, the first side 244 may be opposite relative to the second side 246. The main body 230 of the cooking station 200 may include an upper portion 250, the upper portion 250 including the first and second cooking portions 202, 204 therein. The upper portion 250 defining an upper edge 252 extending along each of the above described front and rear sides 236, 238 and first and second sides 244, 246 to define a rectangular periphery of the main body 230 along the upper edge 252. The upper edge 252 may also define a cross-member 254 that may extend between the front side 236 and the rear side 238 of the upper edge 252, the cross-member 254 defining a separation between the first and second cooking portions 202, 204 of the main body 230. The cross-member 254 may extend between the front and rear sides 236, 238 of the upper edge 252 at about a mid-point therealong so that the first and second cooking portions 202, 204 may exhibit substantially equal cooking spaces or regions of the cooking station 200. The griddle member 212 may be positioned along the upper edge 252 adjacent the first side 244 and partial substantially equal portions of the upper edge 252 along the front and rear sides 236, 238 as well as on the cross-member 254. Further, the first cooking portion 202 may include burner valves 258 or knobs along a front panel 256 positioned along the front side 236 of the upper portion 250 of the main body 230. Each burner valve 258 may be associated with one of the first heating elements 214, similar to the first heating elements 16 of FIG. 2. The front panel 256 may also include an igniter switch 262 for igniting the first heating elements 214 for heating the griddle member 212. Further, the main body 230 may include a single side shelf 260 positioned adjacent the griddle member 212 along the first side 236 of the main body 230. Such side shelf 260 may include various features, such as an elongated opening and ridge arrangement, to discourage users from placing various cooking items or tools too close to the griddle member 212, similar to that disclosed in commonly owned U.S. Pat. No. 10,779,682, filed Mar. 25, 2019, entitled “OUTDOOR COOKING STATION, SIDE SHELF, AND METHOD THEREOF,” the disclosure of which is incorporated herein by reference in its entirety.

As previously set forth, the upper portion 250 of the main body 230 may also support the second cooking portion 204 of the cooking station 200. The second cooking portion 204 may include a pivoting lid 264 that may pivot about a hinge (not shown) along the rear side of the main body 230. Further, the second cooking portion 204 may define an underside panel 266 that may extend below or lower than the front panel 256 or be substantially level with a lower edge of the front panel 256, which may extend along an underside of the upper portion 250 between the cross-member 254 and the second side 246 of the main body 230 and the front and rear sides 236, 238 of the main body 230. In one embodiment, the underside panel 266 of the second cooking portion 204 may be in the form of a barrel belly type structure. The underside panel 266 and the pivoting lid 264 of the second cooking portion 204 may define a smoker chamber 270 that may be accessible by moving the pivoting lid 264 to an open position.

The smoker chamber 270 may include a smoke shield 272 therein, positioned horizontally on brackets, for example, so as to divide the smoker chamber 270 between an upper smoker region 274 and a lower smoker region 276, similar to the previous embodiment. Further, the upper smoker region 274 may include the grill 222 or grate like structure positioned just above the smoke shield 272, the grill 222 extending to define the second cooking surface 220 of the cooking station 200. The upper smoker region 274 may additionally include hooks for hanging food to be cooked within the upper smoker region 274. In one embodiment, the grill 222 or second cooking surface 220 may be positioned horizontally to be substantially level with the first cooking surface 210, such as the griddle member 212. In another embodiment, the grill 222 or second cooking surface 220 may be positioned lower within the smoker chamber 270 such that the grill 222 may be positioned at a level that is lower than the first cooking surface 210. As in the previous embodiment, the second cooking portion 204 may be heated with the pellet feeder system 205, which may include similar structural components as the pellet feeder system 60 cooperating with the lower cooking portion 14 described and depicted relative to FIGS. 4-6. For example, the pellet feeder system 205 may include a pellet hopper 278 for feeding pellets to a second heating element 280 with a motorized auger 280 and controlled from a control panel 284. As such, the pellet feeder system 205 of this embodiment may function in the same manner and include the same structural components as described in the previous embodiment relative to FIGS. 4-6. In this manner, similar to the previous embodiment, the cooking station 200 may operate with separate cooking modes and from separate fuel sources for heating the first and second cooking portions 202, 204 independently and simultaneously all within a stand-alone portable cooking station 200 designed for the outdoors.

The various structural components of the various embodiments of the main body of the cooking station and the pellet feeder system and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art.

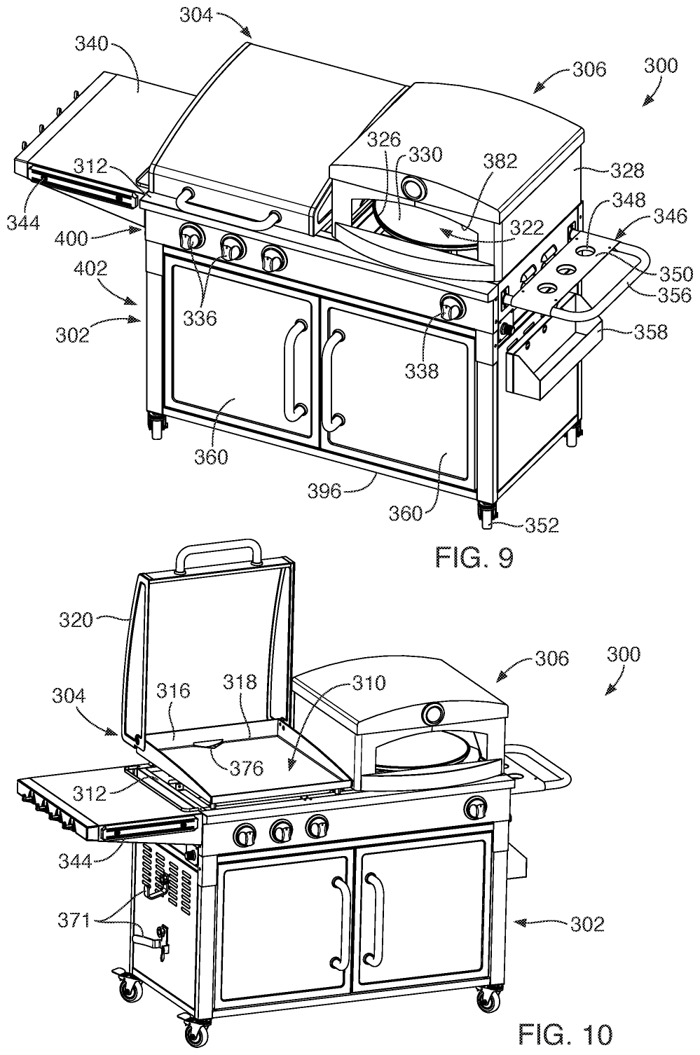

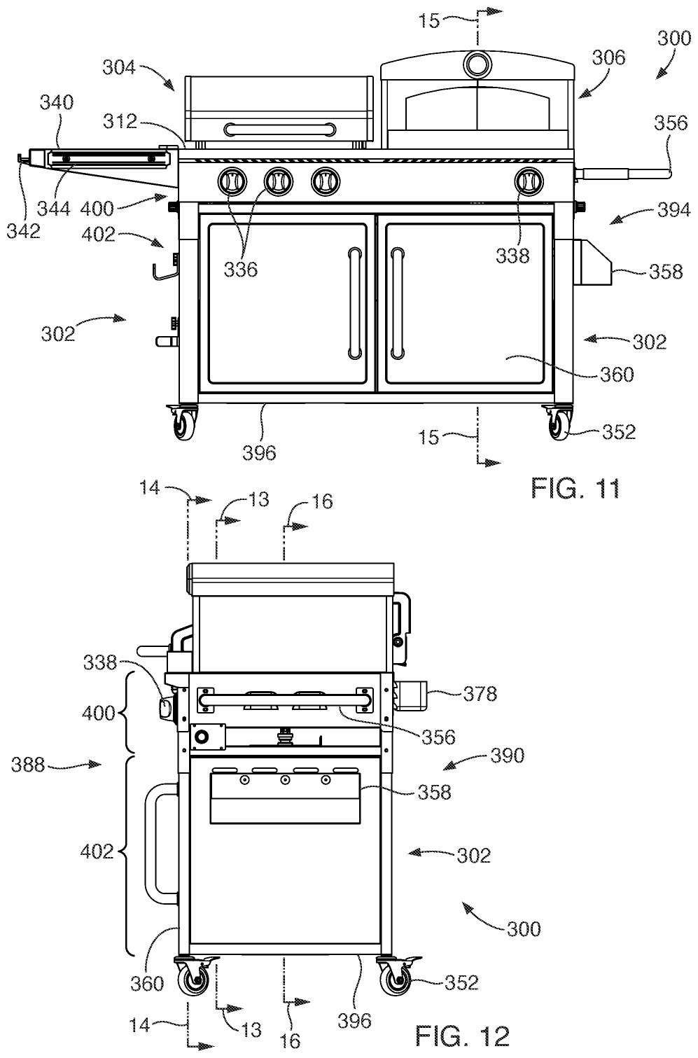

Now with respect to FIGS. 9, 10, 11, 12, and 13, in another embodiment, a cooking station 300 sized and configured to cook food in multiple separate and distinct cooking modes is provided. For example, the cooking station 300 may extend with a main body 302 with a griddle portion 304 and an oven portion 306 as the multiple separate and distinct cooking modes or multiple separate and distinct fuel sources. In this embodiment, the griddle portion 304 and the oven portion 306 may be positioned along the main body 302 in a side-by-side manner. Further, in this embodiment, the griddle portion 304 and the oven portion 306 may cook food separately and simultaneously, at different locations on the cooking station 300 and may be heated from distinct and dedicated fuel sources. In one embodiment, the griddle portion 304 and the oven portion 306 may be gas fueled with propane or natural gas and may include their own dedicated gas burners for the respective griddle portion 304 and the oven portion 306. Such gas burners may include one or more first gas burners 362 and one or more second gas burners 364, the one or more first gas burners 362 configured to fuel the griddle portion 304 and the one or more second gas burners 364 configured to fuel the oven portion 306. Further, the one or more first and second gas burners 362, 364 may be associated with their own dedicated first and second propane tanks (not shown), respectively. In addition, the main body 302 of the cooking station 300 may include a bottom panel 366, the bottom panel 366 defining a first opening 368 and a second opening 370 therein which may also be referenced as respective first and second fuel holding positions. The first and second openings 368, 370 defined in the bottom panel 366 may be sized and configured to hold, or nest with, first and second propane tanks (not shown), respectively, the first and second propane tanks positioned and configured to feed gas to the respective one or more first and second gas burners 362, 364. Further, in another embodiment, a propane tank holding structure 371 as one of the first and second fuel holding positions may be located along one side of the main body 302 of the cooking station 300, as depicted in FIG. 10.

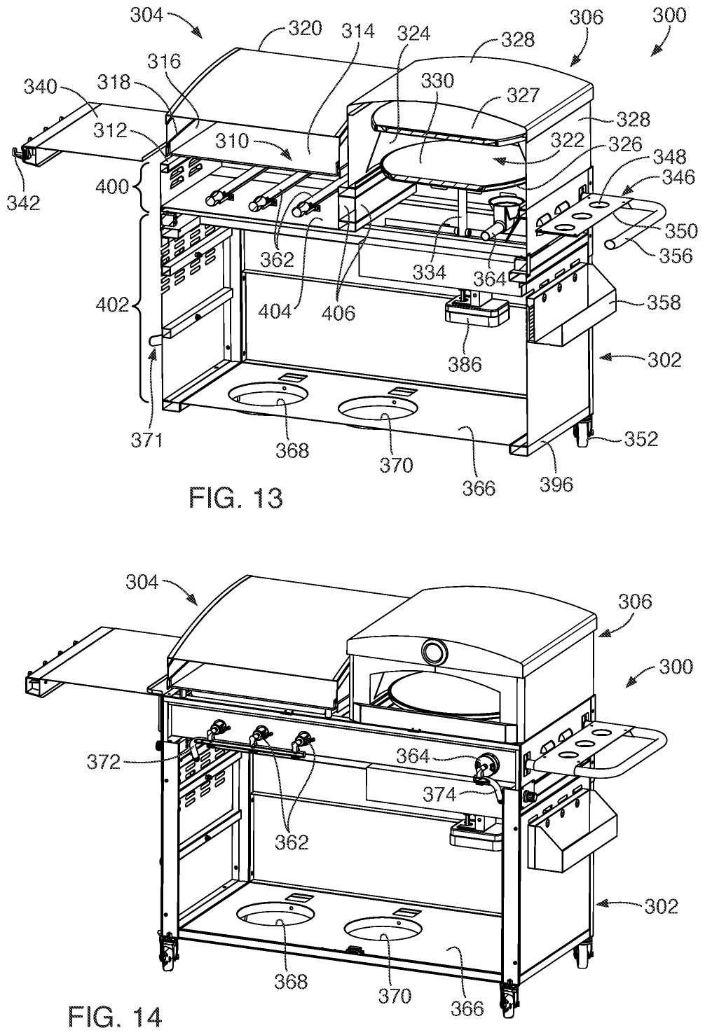

In another embodiment, as depicted in FIGS. 13 and 14, the one or more first and second gas burners 362, 364 may each be coupled to a first fuel tube 372 and a second fuel tube 374, respectively. The first fuel tube 372 may be sized and configured to be interconnected with a first propane tank (not shown) positioned at one of the first opening 368 defined in the bottom panel 366 or the propane tank holding structure 371 alongside the main body 302 of the cooking station 300. Similarly, the second fuel tube 374 may be sized and configured to be interconnected with a second propane tank (not shown) positioned at one of the first and second openings 368, 370 defined in the bottom panel 366 of the main body 302 of the cooking station 300. As such, the first and second fuel tubes 372, 374 may be separate from each other so as to feed gas from separate dedicated fuel sources to the one or more first and second gas burners 362, 364. Further, the one or more first and second gas burners 362, 364 of the cooking station 300 may include various typical components to facilitate igniting and feeding gas to the one or more first and second gas burners 362, 364 for heating the griddle portion 304 and the oven portion 306, respectively, such as various valves, tubing, manifold, gas couplings, fasteners, and any other components, as known to one of ordinary skill in the art.

With reference to FIGS. 10, 13, and 16, the griddle portion 304 may be similar to that depicted in the previous embodiments set forth herein. The griddle portion 304 may include a griddle member 310 positioned over an upper surface 312 of the main body 302 such that the griddle member 310 may be suspended over the one or more first gas burners 362. The griddle member 310 may include a flat griddle cooking surface 314 surrounded by a splash guard 316. The splash guard 316 may extend upward from the flat griddle cooking surface 314 along a periphery 318 of the cooking surface 314. Further the griddle member 310 may include a griddle hood 320 that may be pivotably coupled to, for example, the splash guard 316. In another embodiment, the griddle hood 320 may be pivotably coupled to a main body 302. The griddle hood 320 may be moved between an open position (FIG. 10) and a closed position (FIG. 9). In the closed position, such griddle hood 320 may be useful to protect the griddle member 310 from the outside elements when the griddle member 310 is not being used. Further, the hood 320 may typically be moved to the open position while cooking food on the griddle member 310 and, upon the food being cooked, gas flame burners may be turned off or down so that the hood may be moved to the closed position to keep the food warm on the flat griddle cooking surface 314 of the griddle member 310. In another embodiment, the griddle member 310 may include a griddle opening 376 defined therein. Such griddle opening 376 may be sized and configured to assist in managing grease or food byproduct from cooking on the griddle member 310 such that a grease cup 378 (FIG. 12) may be positioned below and/or rearward of the griddle opening 376 to collect the grease and food byproduct. The griddle portion 304 of the cooking station 300 may include structure and features, such as the griddle opening 376, similar to that disclosed in commonly owned U.S. Pat. No. 10,327,589, filed Dec. 21, 2018, entitled “OUTDOOR COOKING STATION WITH GRIDDLE, SYSTEM AND METHOD THEREOF,” the disclosure of which is incorporated by reference herein in its entirety.

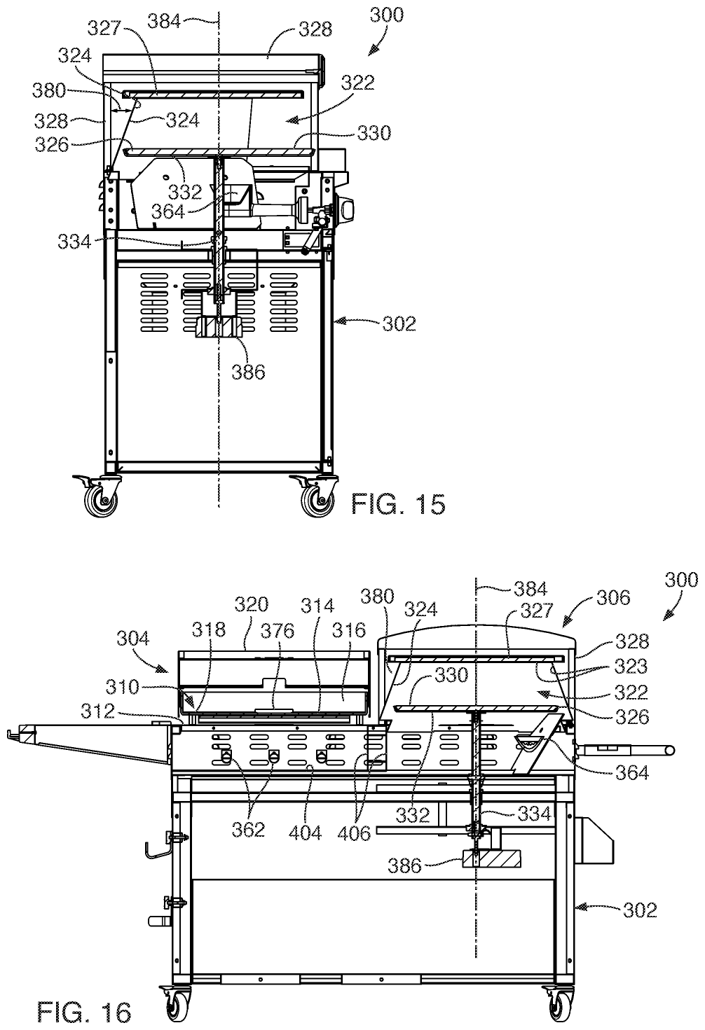

Now with reference to FIGS. 9, 13, 15, and 16, the oven portion 306 may be positioned adjacently to the side of the griddle portion 304 in the before-discussed side-by-side manner. The oven portion 306 may be sized and configured to cook pizza or the like within a cooking chamber 322 of the oven portion 306. The chamber 322 may be defined by an internal wall structure 323 and a lower stone 326. In another embodiment, the cooking chamber 322 may be defined by an internal wall 324, an upper stone 327, and the lower stone 326. In one embodiment, the internal wall structure 323 may extend with the internal wall 324 and the upper stone 327 such that the upper stone may be positioned on a ledge defined by the internal wall 324. In another embodiment, the internal wall structure 323 may act as a heat shield relative to an outer wall 328. Likewise, the internal wall 324 may act as a heat shield between the cooking chamber 322 and the outer wall 328. Such outer wall 328 may at least partially be an external shell or wall of the oven portion 306. Further, the oven portion 306 may define an air gap 380 between the internal wall 324 and the outer wall 326 as well as between the upper stone 327 and the outer wall 328. Also, the cooking chamber 322 may be accessible through a front opening 382, the front opening 382 defined by the internal wall 324 and/or the outer wall 328. Further, the lower stone 326 may define a stone cooking surface 330 sized and configured to cook pizza thereon or other food product within the cooking chamber 322. Further, the upper stone 327 may extend directly above the lower stone 326 in a substantially parallel arrangement such that the upper stone 327 may be heated within the cooking chamber 322 and radiate heat toward the lower stone 326 to assist in the cooking of food. The lower stone 326 may be positioned on a support panel 332. The support panel 332 may include a rod 334 coupled to a central portion of an underside of the support panel 332. The rod 334 may define an axis 384 that extends through a center of the support panel 332 and the lower stone 326. Such rod 334 may be coupled to a motor 386 so that the support panel 332 may be rotated by the motor 386, which in turn rotates the lower stone 326. As such, the motor 386 rotates the lower stone 326 about the axis 384 defined by the rod 334. The cooking chamber 322 of the oven portion 306 with its lower and upper stones 326, 327 may also include and be heated by one or more gas flame burners, such as the before-described one more second gas burners 364, that may be positioned below the support panel 332 and the lower stone 326. The oven portion 306 of the cooking station 300 may include structure and features similar to that disclosed in commonly owned U.S. Pat. No. 9,182,129, filed Feb. 20, 2014, entitled “SYSTEM, DEVICE, AND METHOD FOR BAKING A FOOD PRODUCT,” the disclosure of which is incorporated by reference herein in its entirety.

With reference to FIGS. 9, 11, 12, and 13, the main body 302 of the cooking station 300 may extend to define a cabinet type structure with a front side 388, a rear side 390, a first side 392 and a second side 394. The front side 388 may be positioned opposite of the rear side 390 and the first side 392 may be positioned opposite of the second side 394 of the main body 302. Further, the main body 302 may extend with frame components and panels such that the panels of the front and rear sides 388, 390 may extend generally parallel relative to each other and the panels of the first and second sides 392, 394 may extend generally parallel relative to each other. Further, each of the front and rear sides 388, 390 and the first and second sides 392, 394 of the main body 302 may extend between a lower end 396 and the upper surface 312 of the main body 302. Also, the cabinet structure of the main body 302 may extend to define an upper portion 400 and a lower portion 402 thereof. The griddle portion 304 and the oven portion 306 may be supported by the main body 302 and, in some embodiments, may be supported by the upper portion 400 of the main body 302. Further, the gas flame burners for both the griddle portion 304 and the oven portion 306 may be positioned between the front and rear sides 388, 390 within the upper portion 400 of the main body 302. In another embodiment, both the griddle member 310 of the griddle portion 304 and the lower stone 326 of the oven portion 306 may be positioned at a level above the upper surface 312 of the main body 302. As such, the flat griddle cooking surface 314 of the griddle member 310 and the flat stone cooking surface 330 of the lower stone 326 may be positioned at a higher level or above the upper surface 312 of the main body 302.

In another embodiment, the front side 388 of the main body 302 of the cooking station 300 may include gas burner knobs positioned thereon. The gas burner knobs may include one or more first gas burner knobs 336 and one or more second gas burner knobs 338. The one or more first gas burner knobs 336 may correspond with the one or more first gas flame burners 362 that may be solely dedicated to heating the griddle portion 304 of the cooking station 300. The one or more second gas burner knobs 338 may correspond with the one or more second gas flame burners 364 that may be solely dedicated to heating the oven portion 306 of the cooking station 300. As previously set forth, the one or more first and second gas flame burners 362, 364 may feed fuel from separate fuel sources and/or may be employed independently and simultaneously so as to be able to heat the griddle portion 304 and/or the oven portion 306 independently and simultaneously, if desired.

In another embodiment, the main body 302 may include a side shelf 340 on one side of the main body 302, such as the first side 392 and/or the second side 394 of the main body 302. The side shelf 340 may include hooks 342 and a magnetic strip 344 for holding various cooking utensils, for example. Such side shelf 340 may be level with the upper surface 312 of the main body 302. In another embodiment, one side of the main body 302, such as an opposite side of the side shelf 340, may include a pizza peel holder 346. Such pizza peel holder 346 may include openings 348 defined in a horizontally extending structure 350, the openings 348 sized and configured to receive and support a handle of a pizza peel. To assist in the portability of the cooking station 300, the cooking station may include wheels 352 along the lower end 396 or an underside of the main body 302. Further, the pizza peel holder 346 may also incorporate a handle 356 to assist in moving the cooking station 300. In this manner, the cooking station 300 may be readily movable and a portable structure. In another embodiment, the main body 302 may include a tray 358 positioned along one side, such as below the pizza peel holder 346, or along the front side 388 of the main body 302. Such tray 358 may be sized and configured to hold cooking spices or cooking implements or the like. The main body 302 may also include a cabinet like structure with doors 360 that may be opened to access a lower portion 402 of main body 302 of the cooking station 300, which also facilitates accessing the first and second tank openings 368, 370 defined in the bottom panel 366 configured to support first and second propane tanks, for example.

With reference to FIGS. 13 and 16, in another embodiment, the main body 302 may include structure for controlling heat flow between the griddle portion 304 and the oven portion 306 of the cooking station 300. For example, the main body 302 may include a first heat shield 404 and a second heat shield 406 positioned within the upper portion 400 of the main body 302. The first heat shield 404 may be a panel structure that may extend generally horizontally below the one or more first gas burners 362 and above the level of the doors 360 of the cabinet structure of the main body 302. As such, the first heat shield 404 may assist in blocking or minimizing heat flow toward various components of the oven portion 306, such as the motor 386, as well as assist in blocking or minimizing heat flow toward the region holding the propane tanks, accessible via the doors 360, within the lower portion 402 of the main body 302. The second heat shield 406 may include one or more vertically extending panels positioned below the upper surface 312 of the main body and extending toward the level of the first heat shield 404 or to about the level of an upper end of the doors 360 within the upper portion 400 of the main body 302. Further, the second heat shield 406 may extend with multiple panels extending at least partially below the griddle portion 304 and the oven portion 306 such that the second heat shield 406 may extend along a transition between the griddle portion 304 and the oven portion 306 of the cooking station 300. The second heat shield 406 may be sized and configured to further assist in blocking or minimizing heat flow from the first gas burners 362 toward the functional components of the oven portion 306. Furthermore, the first and second heat shields 404, 406 may assist in blocking or minimizing heat flow from the one or more second gas burners 364 of the oven portion 306 toward the griddle member 310. In this manner, the first and second heat shields 404, 406 positioned within the main body 302 may assist in controlling or minimizing heat flow between the griddle portion 304 and the oven portion 306. As such, the cooking station 302 may safely operate with multiple cooking modes for cooking food at two separate locations in a single stand-alone cooking station and at the same time or simultaneously. Further, the cooking station 300 facilitates cooking food in two separate cooking modes on a flat griddle surface 314 as well as a flat stone surface 330 that may each be heated independent of each other and heated simultaneously.

The various structural components of the various embodiments of the cooking station 300 with the griddle portion 304 and the oven portion 306 and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art. In addition, the griddle member 310 may be manufactured from metallic materials, such as, carbon steel, cast iron, stainless steel, or aluminum, or various metal alloys, or even the composite layering of materials, or any other suitable cooking surface material known in the art, such as porcelain coated materials. Further, in some embodiments, the metallic material of the griddle member 310 may be manufactured using cold rolled steel processes, or hot rolled steel techniques, or any other known manufacturing process, such as casting or stamping, as known in the art. The various plate components of the griddle member 310 may include a thickness of 5-6 millimeters, but is not so limited, as such thickness of the various components of the griddle member may range, for example, between 4-10 millimeters. Furthermore, the “stone” of the lower and upper stones 326, 327 described in the oven portion 306 may be a term of art for “a pizza stone” and may be formed from a ceramic material, a cordierite material and/or a composite material or combinations/blends thereof.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor cooking station configured to simultaneously and independently cook food with separate cooking modes, the outdoor cooking station comprising:
a main body extending to define a griddle portion and an oven portion, the griddle portion including a griddle member having a flat griddle surface such that the griddle member is configured to be supported by the main body and positioned above one or more first gas burners, the oven portion positioned adjacently to one side of the griddle member, the oven portion including a cooking chamber defined by a lower stone and an upper stone and an internal wall, the internal wall acting as a heat shield relative to an outer wall of the oven portion, the lower stone having a stone cooking surface positioned adjacent one or more second gas burners, the stone cooking surface and the griddle cooking surface being sized and configured to cook food independently from each other such that the one or more first gas burners are dedicated to solely heat the griddle cooking surface and the one or more second gas burners are dedicated to solely heat the stone cooking surface within the cooking chamber of the oven portion.

2. The outdoor cooking station of claim 1, wherein the main body comprises one or more heat shields extending below the one or more first gas burners and between the griddle portion and the oven portion of the main body.

3. The outdoor cooking station of claim 1, wherein the griddle portion includes a griddle hood pivotably coupled to the griddle member.

4. The outdoor cooking station of claim 1, wherein the cooking station includes burner knobs, some of the burner knobs solely dedicated to heat the griddle portion and one or more of the burner knobs solely dedicated to heat the oven portion.

5. The outdoor cooking station of claim 1, wherein the lower stone is positionable on a support panel, the support panel being sized and configured to rotate for rotating the stone cooking surface.

6. A portable outdoor cooking station configured to simultaneously and independently cook food with a first fuel source and a second fuel source, the portable outdoor cooking station comprising:
a main body extending to define a front side, a rear side, a left side and a right side each extending between a lower end and an upper portion, the main body including one or more first gas flame burners and one or more second gas flame burners each controlled along the front side and coupled to the main body;
a griddle portion including a griddle configured to be supported by the upper portion of the main body and positioned above the one or more first gas flame burners, the griddle having a flat griddle cooking surface with a splash guard extending upward from a periphery of the flat griddle cooking surface; and
an oven portion extending to define an external wall with an oven opening defined therein, the oven opening sized and configured to access a cooking chamber of the oven portion, the cooking chamber defined by an internal wall structure and a flat stone cooking surface, the internal wall structure spaced from the external wall to define an air gap therebetween, the oven portion supported by the main body and heated by the one or more second gas flame burners;
wherein the flat griddle cooking surface and the flat stone cooking surface are each configured to cook food independent of each other and simultaneously from the first fuel source and the second fuel source, respectively.

7. The portable outdoor cooking station of claim 6, wherein the main body comprises one or more heat shields extending below the one or more first gas flame burners and between the griddle portion and the oven portion of the main body.

8. The portable outdoor cooking station of claim 6, wherein the internal wall structure comprises an upper stone, the upper stone extending substantially parallel relative to the flat stone cooking surface.

9. The portable outdoor cooking station of claim 6, wherein the internal wall structure comprises a heat shield, the heat shield extending to at least partially surround the flat stone cooking surface.

10. The portable outdoor cooking station of claim 6, wherein the flat stone cooking surface comprises a lower stone, the lower stone positioned on a support panel such that the support panel is positioned adjacent the one or more second gas flame burners.

11. The portable outdoor cooking station of claim 10, wherein the support panel comprises a rod coupled centrally to the support panel, the rod extending downward from the support panel to a motor, the motor configured to rotate the rod so that the support panel and the lower stone rotate.

12. The portable outdoor cooking station of claim 10, wherein the one or more second gas flame burners is positioned below the support panel so that heat from the one or more second gas flame burners moves along an underside of the support panel and so that heat moves upward through a gap between the support panel and the internal wall structure.

13. The portable outdoor cooking station of claim 6, wherein the one or more first gas flame burners is coupled to a first hose, the first hose configured to feed fuel from the first fuel source and to the one or more first gas flame burners, and wherein the one or more second gas flame burners is coupled to a second hose, the second hose configured to feed fuel from the second fuel source and to the one or more second gas flame burners.

14. The portable outdoor cooking station of claim 6, wherein the main body includes burner knobs along the front side of the main body, some of the burner knobs solely dedicated to control gas flow through the one or more first gas flame burners to provide heat to the griddle portion, and some of the burner knobs solely dedicated to control gas flow through the one or more second gas flame burners to provide heat to the oven portion.

15. The portable outdoor cooking station of claim 6, wherein the griddle portion comprises a griddle hood, the griddle hood sized and configured to cover the flat griddle cooking surface.

16. A method for cooking food in the outdoors with a first fuel source and a second fuel source, the method comprising:
providing a portable outdoor cooking station with a main body, the portable outdoor cooking station extending to define a griddle portion and an oven portion each supported by the main body, the griddle portion including a griddle cooking surface positioned above one or more first gas flame burners, the oven portion including an external wall defining an oven opening therein for accessing a cooking chamber, the cooking chamber defined by an internal wall structure and a stone cooking surface such that the cooking chamber is configured to be heated with one or more second gas flame burners;
heating the griddle cooking surface with the one or more first gas flame burners that are configured to receive fuel from the first fuel source and configured to solely heat the griddle cooking surface; and
heating the cooking chamber with the one or more second gas flame burners that are configured to receive fuel from the second fuel source and configured to solely heat the cooking chamber of the oven portion.

17. The method according to claim 16, further comprising minimizing heat flow from the heating the griddle cooking surface toward the cooking chamber of the oven portion with one or more heat shields positioned adjacent to the one or more first gas flame burners of the griddle portion.

18. The method according to claim 16, wherein the heating the griddle cooking surface comprises activating one or more first burner knobs positioned along a first side of the main body and directly linked to the one or more first gas flame burners.

19. The method according to claim 16, wherein the heating the cooking chamber comprises activating one or more second burner knobs positioned along a second side of the main body and directly linked to the one more second gas flame burners.

20. The method according to claim 16, wherein the heating the griddle cooking surface and the heating the cooking chamber comprises heating the griddle cooking surface and the cooking chamber independently and simultaneously.
